(19) United States
(12) Patent Application Publication
(10) Pub. No.: US 2017/0364106 A1
(43) Pub. Date: Dec. 21, 2017

(54) SYSTEMS AND METHODS FOR PROVISIONING COMPONENTS OF AN HVAC SYSTEM

(71) Applicant: Trane International Inc., Davidson, NC (US)

(72) Inventors: Christopher Blake Smith, Whitehouse, TX (US); Kit W. Klein, Tyler, TX (US)

(73) Assignee: Trane International Inc., Davidson, NC (US)

(21) Appl. No.: 15/538,468

(22) PCT Filed: Dec. 21, 2015
(86) PCT No.: PCT/US2015/067130

§ 371 Date: Jun. 21, 2017

Related U.S. Application Data
(60) Provisional application No. 62/095,294, filed on Dec. 22, 2014.

(51) Int. Cl. G05D 23/30; H04L 12/28; F24F 11/00; H04L 12/24

(52) U.S. Cl. CPC G05D 23/306; H04L 41/0809; H04L 12/282; F24F 11/006; F24F 2011/0071; G05B 2219/2642

(57) ABSTRACT

Systems and methods for provisioning a component of an HVAC system are presented. A provisioning device, such as a smartphone, is used to scan HVAC component information obtained from a tag on each component and wirelessly transfers the information to a thermostat or HVAC system controller. The thermostat or system controller automatically configures itself to control the equipment based on the details in the tag which are transmitted to the thermostat. The label may include barcode or textual information, which is decoded by software executing in the provisioning device, the thermostat, or a server computer in communication with the provisioning device or the thermostat. In embodiments, the HVAC component information is transmitted to a web services application to facilitate the installation, support, maintenance, and repair of the HVAC system.

### BACKGROUND

### 1. Technical Field

The present disclosure relates generally to a heating, ventilation, and air conditioning (HVAC) system. More specifically, this disclosure relates to the provisioning of components in an HVAC system.

### 2. Background of Related Art

A heating, ventilation, and air conditioning (HVAC) system generally includes equipment configured to control one or more environmental conditions such as, but not limited to, temperature, humidity, air quality, or the like. An HVAC system is generally equipped with a number of HVAC components, such as a thermostat, system controller, air handler, condenser, evaporator, heat pump, furnace, one or more dampers, and so forth, which interact to provide the desired environmental condition within a facility. The function and control of the HVAC equipment is typically adjusted by a thermostat, which can alternatively be a part of an HVAC system controller.

The types of components installed, and the capacity and features of each component, are determined in accordance with the requirements of the overall HVAC system. For optimal system performance, device information relating to the characteristics of a component in the system is provided to other components of the system in a process known as provisioning. For example, tonnage and compressor speed control parameters of a condenser unit may be provided to a thermostat, which, in turn, enables the thermostat to properly control the compressor and to take advantage of its energy conservation features. In addition, device information may be provided to a database for use by sales and service personnel to facilitate customer support, maintenance, service, and other functions.

### SUMMARY

In one aspect, the present disclosure is directed to configuring a residential thermostat or system controller using a provisioning device. The provisioning device is configured to scan system component information obtained from a tag on each component and wirelessly transfer the information to the thermostat. The thermostat then configures or “provisions” itself to interact with and control the equipment based on the details in the tag. In embodiments, the tag is a label having a barcode, which is read by a barcode scanning function included in the mobile device. In embodiments, the tag is a label having textual information which is read by an optical character recognition (OCR) function included in the mobile device. In embodiments, the label may be a transponder device, such as a radiofrequency identification (RFID) tag, a near-field communication (NFC) device, and the like, which communicates with a compatible device in the provisioning device.

The provisioning device may include a mobile device, such as a smart phone, and allows a user, such as an installer or homeowner, to easily obtain information from the tag on each piece of equipment situated at a site. For example, barcoded information ensures the thermostat is configured to exactly match the equipment to which it is connected. The installer would install each piece of equipment in a normal fashion. Upon application of power and/or upon actuation of a setup mode by the user, the thermostat or controller establishes an ad-hoc WiFi network. The user employs a mobile device, such as a smartphone or tablet computer, to connect to the ad-hoc WiFi network. Upon connecting to the ad-hoc network, a configuration app begins executing on the mobile device. In an embodiment, the configuration app is a web app that is downloaded from the thermostat, controller, or from a remote device via the Internet. In an embodiment, the web app automatically downloads to the mobile device and begins execution when the mobile device connects to the ad hoc network.

During use of an embodiment, a user utilizes a barcode scan function within the configuration app to capture a configuration barcode on a tag located on each piece of equipment. As each barcode is captured, the app decodes the contents and conveys the configuration data to the thermostat via the ad-hoc connection. The thermostat or controller receives the configuration data and configures its operating parameters to best match the piece of equipment just scanned. After all tags are scanned, the thermostat is fully provisioned, and ready for use.

In another embodiment, a user utilizes an OCR function within the configuration app to capture alphanumeric text, such as a model number, serial number, or other equipment-related data (e.g., tonnage, voltage, cubic feet per minute, etc.) from a tag located on each piece of equipment. In yet another embodiment, a photographic image of the tag is captured and transmitted to a remote device for analysis. The image may be captured and/or transmitted by the configuration app, or may be captured by a conventional camera app on the user device and transmitted by email, multimedia messaging service (MMS), or any suitable transmission protocol.

In another aspect, the present disclosure is directed to a service system. The system includes a mobile device app that is configured to communicate with a site database that is accessible by a sales or service organization. An installer, delivery person, or other personnel uses a scan function within the configuration app to capture an image of a configuration barcode or text on the tag on each piece of equipment. As each barcode or textual element(s) is/are captured, the app decodes the image contents to derive configuration data, and conveys the configuration data to the site database via a wireless network connection, such as without limitation, a WiFi, cellular, or other suitable wireless network connection. Additional data, such as geographic information and/or installer information may be conveyed to the site database. The sales or service organization may access the site database to determine which equipment is at a site to facilitate sales support, maintenance, troubleshooting, and repair of the equipment.

In accordance with an aspect of the present disclosure, a method of provisioning an HVAC system controller includes activating, at the HVAC system controller, a system provisioning mode. A communications interface operatively coupled with the HVAC system controller solicits a connection with a provisioning device and a communications link is established between the HVAC system controller and the provisioning device. The provisioning device receives HVAC component data included in an image captured by the provisioning device, and the HVAC system controller is provisioned using the HVAC component data included in the image.

In another aspect of the present disclosure, the HVAC system controller solicits a connection with a provisioning device by establishing an ad hoc wireless network.

In another aspect, the disclosed method further includes detecting when a communications link between the HVAC system controller and the provisioning device is established, and transmitting a configuration application from the HVAC system controller to the provisioning device. In yet another aspect, the configuration application enables the provisioning device to capture the image. In still another aspect, the configuration application enables the provisioning device to decode HVAC component data included in the image. In another aspect of the present disclosure, a product database is queried using HVAC component data included in the image. In a further aspect, the HVAC system controller received additional HVAC component data from the product database, and the HVAC system controller is provisioned with the additional HVAC component data.

In another aspect of the present disclosure, the HVAC system controller receives supplemental data from the provisioning device. In another aspect, the HVAC system controller is provisioned with the supplemental data.

Aspects of the present disclosure include a system for managing HVAC configuration data. The system includes a mobile device configured to capture an image of an HVAC component, an image decoding module in operable communication with the mobile device configured to receive the image of the HVAC component and derive HVAC component data therefrom, and a database in operable communication with the image decoding module configured to store the derived HVAC component data. In another aspect, the disclosed system includes an HVAC controller in operable communication with the database. The HVAC controller is configured to receive the HVAC component data. In yet another aspect, the HVAC controller is configured to provision an operational parameter thereof in response to the received HVAC component data. In yet another aspect, the disclosed system includes an information server in operable communication with the database. The information server is configured to receive the stored HVAC component data. In still another aspect, an image of an HVAC component includes an image of an HVAC component shipping container. In yet a further aspect, an image of an HVAC component includes an image of an HVAC component tag. In another aspect, an image of an HVAC component includes a linear barcode, a two-dimensional barcode, and/or alphanumeric text. In still another aspect, the disclosed system include a user computer in operable communication with the database. The user computer is configured to display the image of an HVAC component to a user, to enable the user to transcribe HVAC component data derived from the image into the database.

In accordance with a further aspect of the present disclosure, a method of managing an HVAC system is disclosed. The disclosed method includes receiving, from a provisioning device, an image of a tag associated with an HVAC component. At an image decoding module, HVAC component data is derived from the image of the tag and stored into a database. At least a part of the derived HVAC component data is transmitting to an HVAC controller, and the HVAC controller is provisioned with the transmitted HVAC component data. In some embodiments, an operational status of the HVAC system is determined from the HVAC component data, a work order is generated based upon the operational status of the HVAC system, and the work order is delivered to a service provider. In some embodiments, an operational parameter to the HVAC system is determined from the derived HVAC component data. The operational parameter is transmitted to the HVAC controller, and the HVAC controller is provisioned with the operational parameter. In some embodiments, a database is queried with the derived HVAC component data to obtain the operational parameter. In some embodiments, a geographic location of the HVAC component is received from the provisioning device and stored into a database.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the drawings wherein:

FIG. 1 illustrates a block diagram of a mobile device and a thermostat in accordance with an embodiment of the present disclosure;

FIG. 2 illustrates a block diagram of an information server and a user computer in accordance with an embodiment of the present disclosure;

FIG. 3 illustrates a schematic diagram of a thermostat provisioning system in accordance with another embodiment of the present disclosure;

FIG. 4 illustrates an equipment tag for use with a thermostat provisioning system in accordance with an embodiment of the present disclosure;

FIG. 5 illustrates a schematic diagram of a thermostat provisioning system in accordance with another embodiment of the present disclosure;

FIG. 6 illustrates a flowchart of a method of provisioning a thermostat in accordance with an embodiment of the present disclosure; and

FIG. 7 illustrates a flowchart of a method of provisioning a thermostat in accordance with another embodiment of the present disclosure.

The various aspects of the present disclosure mentioned above are described in further detail with reference to the aforementioned figures and the following detailed description of exemplary embodiments.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure may be described herein in terms of functional block components, code listings, optional selections, page displays, and various processing steps. It should be appreciated that such functional blocks may be realized by any number of HVAC vapor-pressure cycle components, electronic components, and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device, on a variety of operating systems, including without limitation Apple OSX®, Apple iOS®, Google Android®, HP WebOS®, Linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented. Moreover, two or more steps or actions recited herein may be conducted concurrently.

The disclosed systems and/or methods may be embodied, at least in part, in application software that may be downloaded, in whole or in part, from either a public or private website or an application store (“app store”) to the mobile device. In another embodiment, the disclosed system and method may be embodied, at least in part, in HVAC device firmware, hardware, and/or software. In another embodiment, the disclosed system and method may be embodied in, at least in part, the mobile device firmware, hardware, and/or software. In another embodiment, the disclosed systems and/or methods may be embodied, at least in part, in application software executing within a webserver to provide a web-based interface to the described functionality.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

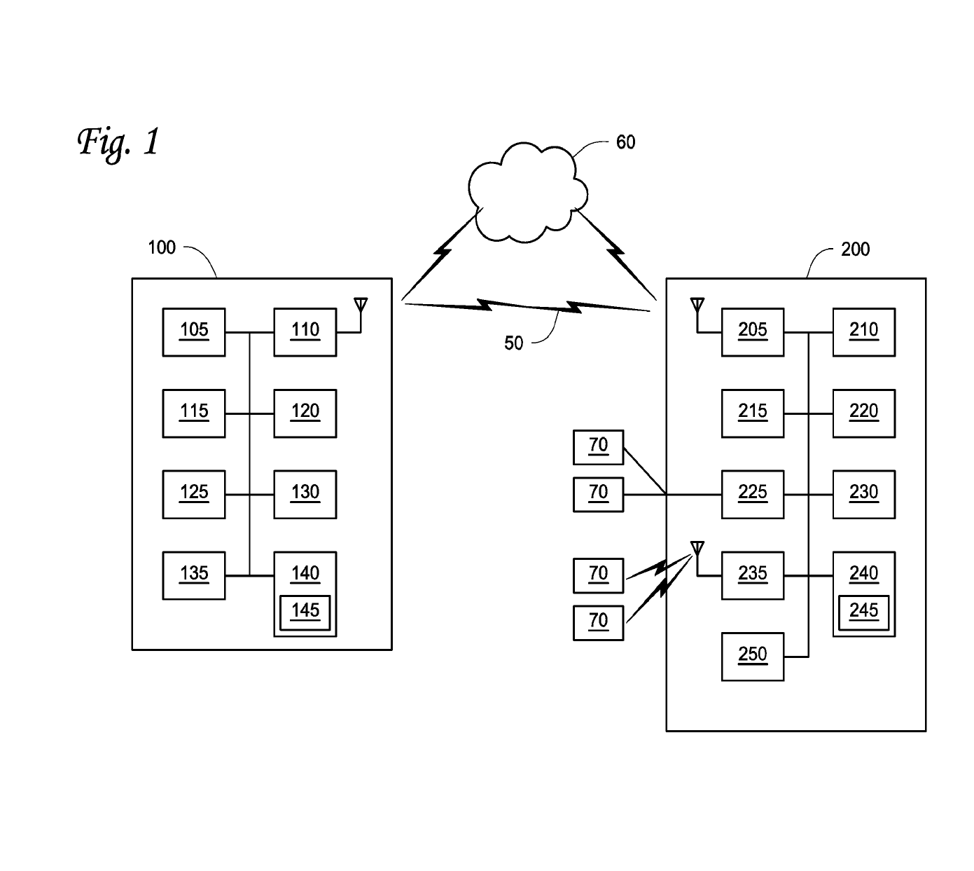

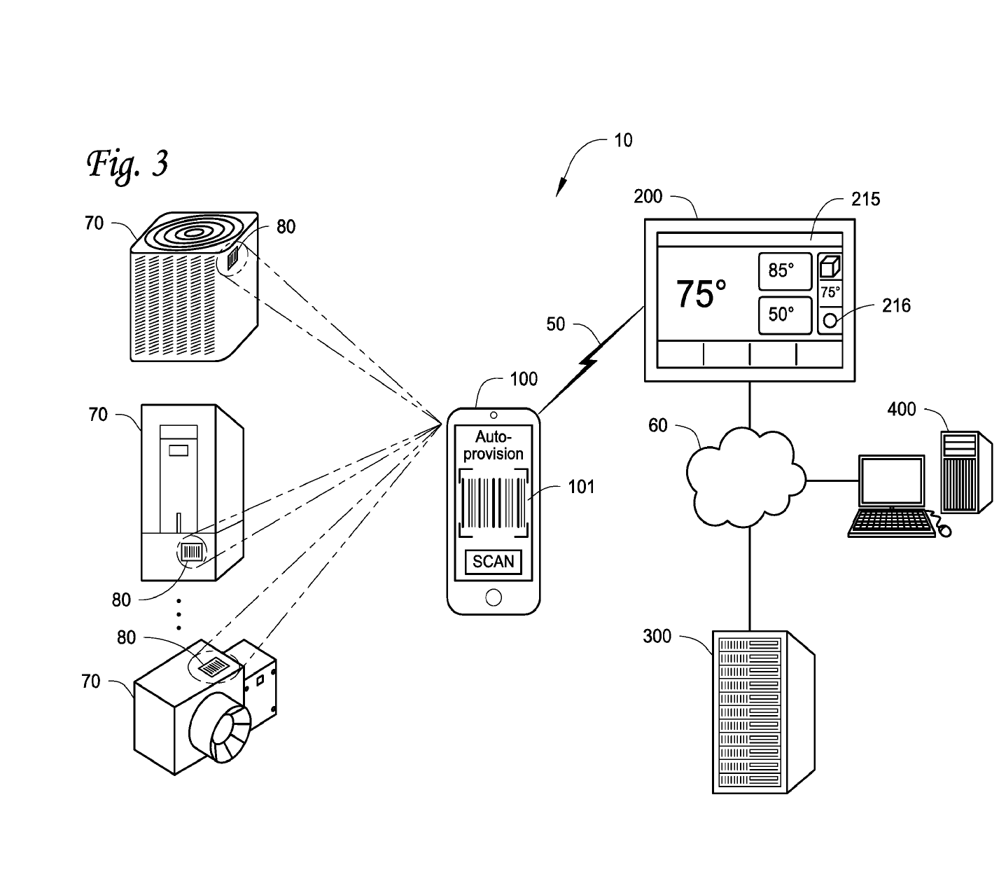

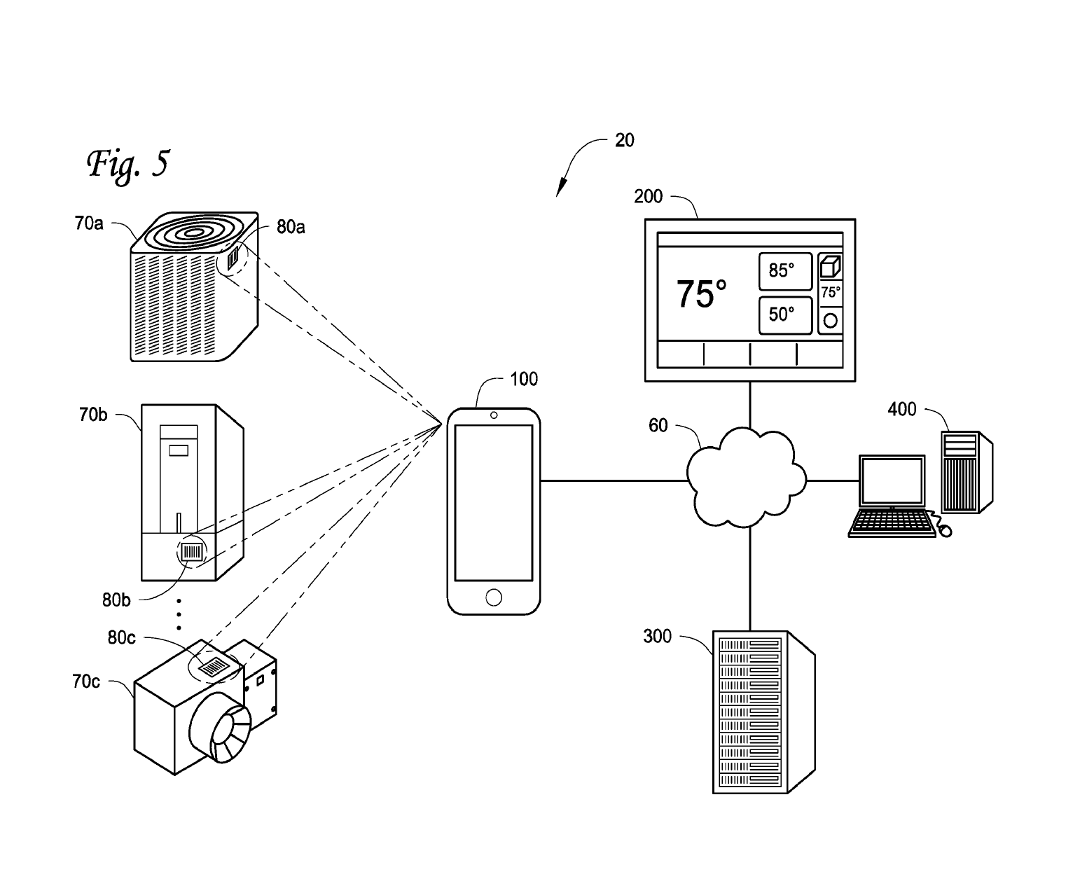

FIG. 1 illustrates a block diagram of a mobile device 100 and a thermostat 200 in accordance with an example embodiment of the present disclosure. Mobile device 100 includes a processor 120 in operative communication with a memory 130, communications interface 110, user interface (UI) 105, camera 115, and a global navigation satellite system (GNSS) receiver 125. In the example embodiment shown in FIG. 1, communications interface 110 includes the capability to communicate using one or more wireless communications protocols, such as, without limitation, cellular (e.g., GSM, CDMA, LTE, etc.), WiFi (IEEE 802.11-compliant variants), near-field communications (NFC) compliant with IEEE 802.15.4 standards (Z-Wave, ZigBee, etc.), Bluetooth® and/or Bluetooth Low Energy (BLE) standards. In addition, embodiments in accordance with the present disclosure may include the capability to communicate additionally or alternatively via a wired or optical communications protocol. In embodiments, communications interface 110 may be configured to communicate in a WiFi ad-hoc mode (FIG. 3) and, additionally or alternatively, in a WiFi infrastructure mode (FIG. 5).

Mobile device 100 includes a transponder 135 that is in operative communication with processor 120 and includes, without limitation, an NFC device and/or an RFID interrogator. GNSS receiver 125 may operate with positioning signals from any GNSS system now or in the future known, including GPS, GLONASS, Iridium, BeiDou, and the like. User interface 105 may include a touchscreen display, one or more buttons, a microphone, and/or a speaker for receiving user input from a user of mobile device 100 and communicate corresponding user input signals to processor 120, and, to display user interface elements to a user of mobile device 100 in response to signals received from processor 120. Mobile device 100 includes a software configuration application 140 having executable instructions, which, when executed by processor 120, cause mobile device 100 to perform a method of configuring an HVAC system component as described herein. Software configuration application 140 includes an image decoding module 145 configured to perform optical character recognition and/or barcode decoding functions.

Thermostat 200 includes a processor 210 in communication with a memory 220, a communication interface 205, and a user interface 215. Thermostat 200 includes the provisioning modes described herein which configure thermostat 200 to receive equipment data from mobile device 100. Processor 210 is configured to retrieve and execute programmed instructions of operating software 240 stored in memory 220. For example, the processor 210 can retrieve and execute programmed instructions of operating software 240 to configure thermostat 200 to receive equipment data from mobile device 100 relating to particular HVAC equipment 70 (FIG. 3) and store said equipment data in a database 230. Operating software 240 includes an image decoding module 245 configured to perform optical character recognition and/or barcode decoding functions. Processor 210 may include any suitable processor, including, without limitation, a single processor, a single processor having multiple processing cores, multiple processors, or the like. Thermostat 200 includes memory 220 that is in operative communication with processor 210. Memory 220 may include, without limitation, a dynamic random access memory, a static random access memory, a flash memory, non-volatile memory, hard drive, solid state drive, hybrid hard drive/solid state drives (SSIID), combinations thereof, or the like. Memory 220 stores a set of executable instructions for execution by processor 210.

Thermostat 200 includes a communication interface 205. In embodiments, communication interface 205 is configured to communicate using at least one of the 802.11 WiFi wireless communications standards, e.g., 802.11a, 802.11b/g/n, 802.11ac, and variants thereof. Communication interface 205 may be configured to communicate in an ad-hoc mode or, additionally or alternatively, in an infrastructure mode.

Thermostat 200 includes a wired equipment interface 225 and a wireless equipment interface 235. Wired equipment interface 225 includes one or more control circuits that are configured to operatively couple with one or more HVAC components 70 and may utilize a simple control scheme based upon switch closures and/or relay actuations to selectively open or close a control circuit, and/or may utilize a networked control protocol using, for example and without limitation, a point-to-point serial connection (RS-232, RS-422) or a multiplexed serial connection (RS-485), a CANBUS connection, and so forth. Wireless equipment interface 235 operates using one or more suitable wireless communication protocols to establish a control circuit, such as, but not limited to, WiFi, Bluetooth®, ZigBee®, Z-Wave®, and the like, to communicate with one or more HVAC components 70, and may additionally communicate with other devices, such as a home automation devices, one or more personal computers, handheld devices, media players, and the like.

Thermostat 200 includes a user interface 215 which, in the some embodiments, includes a combination flat-panel display and a touchscreen human-computer interface device. User interface 215 displays user interface elements as instructed by the processor 210. In some embodiments, the user interface 215 may include a color touchscreen. In some embodiments, user interface 215 can include a combination of user interface elements such as, but not limited to, a physical button, a virtual button, a screen display devices, and visual indicators (e.g., LED indicators). In some embodiments, the display can be a touchscreen or a display-only screen. The user interface 125 can be configured to detect a user input via touch or contact by a human finger or a device such as, but not limited to, a stylus device, or the like. The user interface 215 sends a signal indicative of the detected user input to processor 210. In some embodiments, the HVAC system thermostat 200 can be programmed to monitor additional aspects of the HVAC system.

Thermostat 200 includes an environmental sensor 250 in operable communication with processor 210. In some embodiments, the environmental sensor includes a temperature sensor, such as, without limitation, a thermistor, a thermocouple, a silicon bandgap temperature sensor, an analog or digital temperature sensor integrated circuit, and so forth. In some embodiments, the environmental sensor includes a humidity sensor, a light sensor, an air quality sensor, and/or a proximity sensor configured to detect when a person is in the vicinity of thermostat 200. Environmental sensor 250 may be physically associated with thermostat 200 and/or may be remotely mounted at a physical location separated from thermostat 200 using a hard-wired or wireless connection. In embodiments, thermostat 200 may form all or part of a system controller.

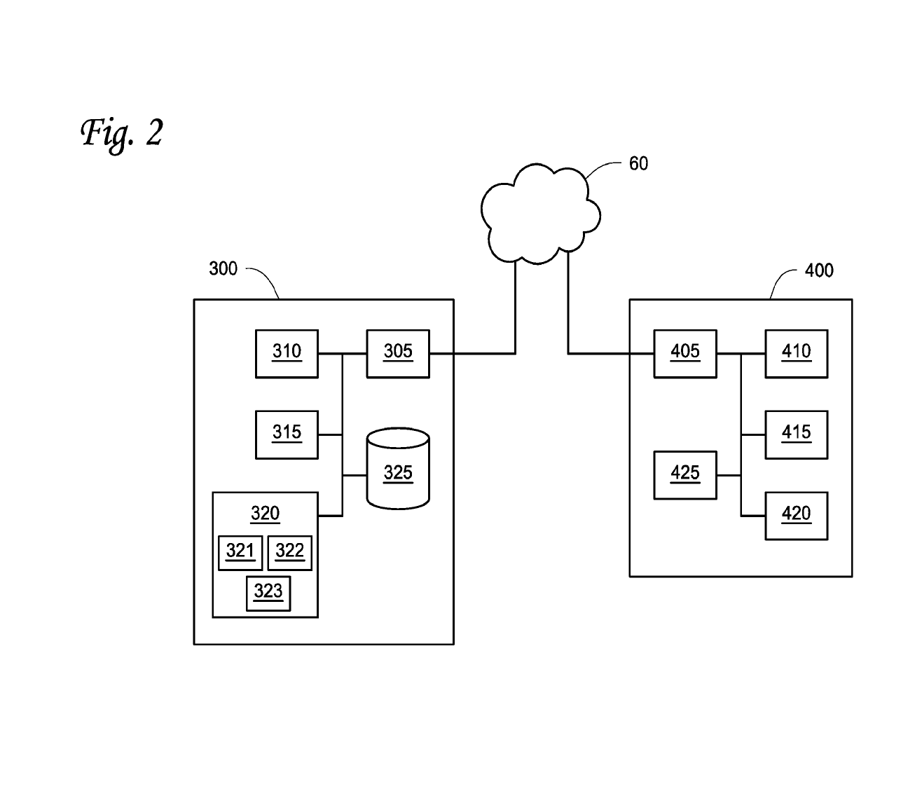

FIG. 2 illustrates a block diagram of an information server 300 and a user computer 400 in accordance with an example embodiment of the present disclosure. Information server 300 includes a processor 310 in operative communication with a memory 315, a communication interface 305, operational software 320, and a database 325. In embodiments, communication interface 305 operatively couples information server 300 with a data network 60, such as the Internet, to enable information server 300 to communicate with mobile device 100, thermostat 200, and/or user computer 400. For example, in embodiments, mobile device 100 transmits HVAC equipment data to information server 300 for processing by operational software 320. Operational software 320, in turn, stores HVAC equipment data received from mobile device 100 in database 325. Operational software 320 includes an image decoding module 323 configured to perform optical character recognition and/or barcode decoding functions. Additional data may be stored in association with the received HVAC equipment data. For example, database 325 may include a relational database structure, and may include one or more tables which relate the received HVAC equipment data to geographic information (e.g., where the equipment is located, numbers and types of other HVAC systems in the same geographic region, etc.), owner information, sales information (e.g., installing dealer, servicing dealer, distributor, etc.), warranty information, and/or service information (e.g., diagnostic, performance, repair, service, and maintenance records).

Operational software 320 includes a webserver 321 and a webapp server 322 to facilitate the processing of, and access to, HVAC equipment data. In embodiments, webapp server 322 includes a configuration webapp (e.g., software coded in a programming language which executes within a browser, such as, without limitation, JavaScript®) that is downloaded to, and executed by, mobile device 100. Webserver 321 is configured to enable user computer 400 to conveniently access stored HVAC equipment data to facilitate after-sales support, service, maintenance and repair of HVAC equipment 70.

User computer 400 includes a processor 410 in operative communication with a memory 415, a communication interface 405, operational software 420, and a user interface 425. In embodiments, communication interface 405 operatively couples user computer 400 with data network 60 to enable user computer 400 to communicate with information server 300. User interface 425 includes one or more user interface devices, such as without limitation, a graphic display, keyboard, pointing device (mouse, touchpad, etc.), touchscreen, and so forth as will be familiar to one skilled in the art. Operational software 420 includes a browser application to enable user computer 400 to access HVAC information provided by information server 300. In embodiments, a mobile device 100 may additionally or alternatively be employed as a user computer 400.

Turning now to FIG. 3, an embodiment of a provisioning system 10 for an HVAC system is shown. Provisioning system 10 includes thermostat 200 that is configured to establish a wireless communications link with a mobile device 100. In use, thermostat 200 is placed into provisioning mode by a user via actuation of a user interface element 216 of user interface 215 designated for this purpose. Upon actuation of provisioning mode, communication interface 205 of thermostat 200 establishes an ad-hoc network 50. Optionally, an authentication credential, such as a password or network key, is associated with ad-hoc network 50. In these instances, the password or network key may be automatically and/or randomly generated by thermostat 200. On other instances, the password or network key may be user-specified. Mobile device 100 is then joined to ad-hoc network 50, with the user entering the specified password if necessary, which places mobile device 100 and thermostat 200 into operative communication. In embodiments, thermostat 200 is programmed to detect when a mobile device 100 has established a connection with thermostat 200 and, in response, causes a landing page 101 to be displayed on mobile device 100. In embodiments, landing page 101 includes a user interface of software configuration application 140. Thermostat 200 is optionally coupled in operative communication with information computer 300 and/or user computer 400 via data network 60, which may be a wide-area network such as the public Internet.

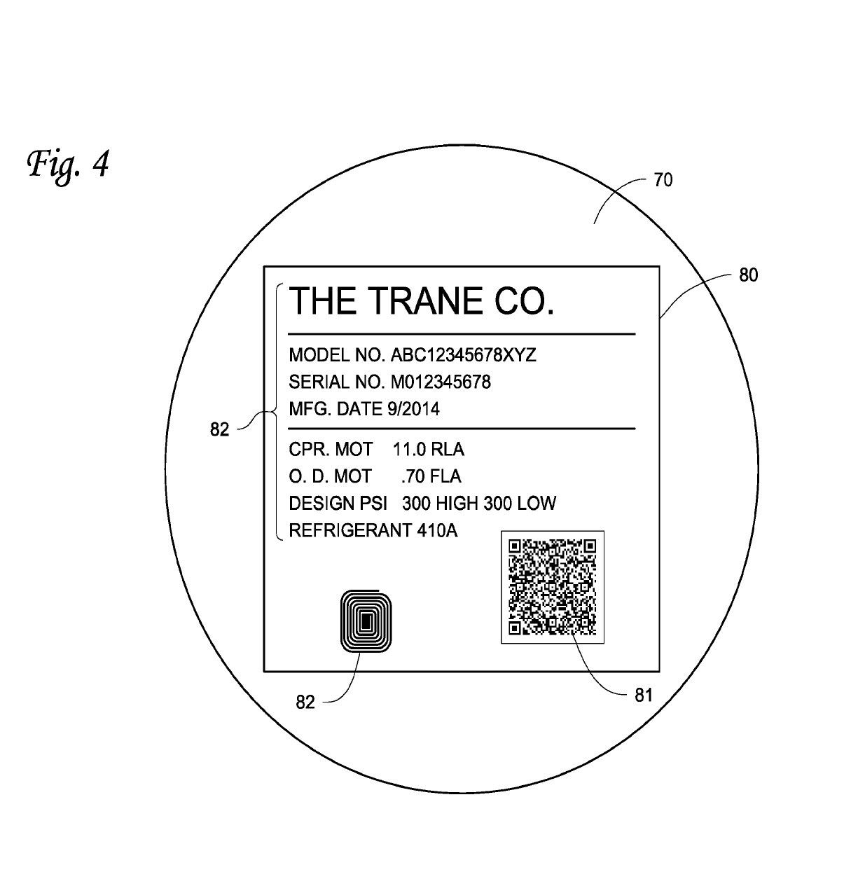

The target HVAC system includes a number of HVAC components 70. Upon initial powering-up, the HVAC system components operate in a stand-alone or reduced functionality mode to provide default control and ventilation until the system is fully provisioned. This enables the installation technician to assess initial operational integrity of the system and to generally allow for use of the system prior to provisioning. An HVAC component 70 configured for automated provisioning includes an identification tag 80 affixed thereto. Advantageously, identification tag 80 is positioned in a manner which facilitates convenient visual access by a user, such as one or more of: on an exterior panel of HVAC component 70, on a shipping container, on an installation manual, and/or on an owner's manual thereof. As illustrated in FIG. 4, identification tag 80 includes equipment data encoded in one or more formats, including barcode-encoded data 81 and/or human-readable format 82. Examples of barcode-encoded data include, without limitation, data encoded using a one-dimensional (1D) barcode symbology such as UPC-A, EAN, USS-128, Code-39; and data encoded using a two-dimensional (2D) symbology such as QR Code, Aztec, and PDF417. Equipment data may additionally or alternatively be encoded in an RFID tag 82 included with identification tag 80. In embodiments where data is presented in both human-readable and machine-readable form on identification tag 80, the human-readable data and machine-readable data may include similar data, or dissimilar data (e.g., the machine-readable data may include additional information not presented in human-readable form). The data elements encoded on identification tag 80 may vary based upon the type of equipment represented by identification tag 80, and may include, without limitation, equipment type, a model number, a serial number, a manufacturing data, a certification identifier, a performance identifier (tonnage, BTUs, SEER, etc.), supported communications protocols, an operating range, and so forth as will be familiar to one skilled in the art.

To provision thermostat 200 to operate with an HVAC component 70, a user utilizes software configuration application 140 of mobile device 100 to capture data from identification tag 80 affixed to HVAC component 70. In embodiments, software configuration application 140 communicates with camera 115 of mobile device 100 to capture an image of at least a part of identification tag 80. In embodiments, software configuration application 140 communicates with NFC 135 of mobile device 100 to receive data from an RFID tag 83 included within identification tag 80. In embodiments, supplemental data is captured by mobile device 100 and associated with the captured tag data. Examples of supplemental data include, without limitation, location data obtained from GNSS receiver 125, by WiFi geolocation, IP geolocation, and/or cellular triangulation; identity of the user and related subscriber data (mobile number, phone make and model, account number etc.) of mobile device 100; a timestamp; and/or additional notes or free-form comments provided by the user of mobile device 100.

In embodiments where identification tag 80 includes human-readable data elements, the captured image is decoded using optical character recognition techniques. In embodiments where identification tag 80 includes barcoded data elements, the captured image is decoded using barcode-decoding techniques. The image decoding may be performed any one of, or combinations of, software configuration application 140 included in mobile device 100, operating software 240 included in thermostat 200, and/or operational software 320 included in information server 300.

In embodiments, image decoding may be performed by a human. In embodiments, an image of identification tag 80 is stored by information server in association with any supplemental data transmitted therewith by mobile device 100. The image of identification tag 80 is presented to a user of user computer 400 who attempts to read any data presented in the tag, and enters the data into information server 300 via a user interface 425 of user computer for subsequent use. In some embodiments, the image of identification tag 80 is queued for manual processing by a human intelligence task worker who performs visual recognition of the data presented in the image of identification tag 80, and transcribes the information presented in the image of identification tag 80 into information server 300. In embodiments, a broader image of HVAC component 70, such as an image of all or part of HVAC component 70, may be captured and presented for decoding and/or processing. In this manner, poor quality images, images captured by a user with poor photographic skills, and other non-optimal images may nevertheless be decoded properly.

Upon decoding of the tag data, the decoded data is received and/or processed by operating software 240 of thermostat 200, and stored in database 230 for use during operation of thermostat 200. A user may continue to scan additional HVAC components 70 to provision thermostat 200. Once all HVAC components 70 have been scanned and provisioned, the user terminates provisioning mode of thermostat 200. The HVAC system is now fully operational, and is thus no longer required to operate in a stand-alone or reduced functionality mode.

In certain instances, if an HVAC component 70 is not fully provisioned, the HVAC component 70 may operate in a partially reduced-functionality state. In addition the entire HVAC system may be operated in a partially reduced-functionality state where each HVAC component operates in a reduced-functionality state. At such time where each HVAC component 70 is fully provisioned, the entire HVAC system is able to run in full-feature mode. The one or more HVAC components 70 communicate provisioning status between and among themselves via the control circuit joining the wired equipment interfaces 225 and/or wireless equipment interfaces 235 thereof.

Another example embodiment of a provisioning system 20 for an HVAC system is shown in FIG. 5. In this embodiment, communication among and between any of mobile device 100, thermostat 200, information server 300, and user computer 400 is achieved via data network 60. Software configuration application 140 may be incorporated as a web app in a landing page provided by information server 300 to mobile device 100 upon the establishment of a connection session between mobile device 100 and information server 300. Additionally or alternatively, software configuration application 140 may be a resident application installed on mobile device 100 from an application server, such the App Store® or GooglePlay®, or downloaded from website, FTP site, or other suitable network resource.

This embodiment is suitable for use in cased where it is desired to store provisioning data centrally in information server 300 to provide a cloud services platform. For example, provisioning data is stored in information server 300 so that in the event thermostat 200 experiences a failure, a replacement thermostat 200 may download the stored provisioning data from information server 300. In this manner replacement thermostat 200 is quickly provisioned from data previously scanned and store online, which reduces downtime, reduces the chance of error, and reduces the time and costs of service calls, among other benefits. In another example, the HVAC system may be installed using a simple thermostat which is not provisionable as described herein. In this instance, the provisioning data of the other components of the HVAC system may be recorded in information server 300 and provisioned with respect to each other. In the event the simple HVAC thermostat is upgraded to a provisionable thermostat 200, the provisioning data previously stored in information server 300 may be downloaded into thermostat 200. By using previously-stored provisioning data downloaded from information server 300, a homeowner or installer can provision new thermostat 200 without having to return to and re-scan the other HVAC equipment on-site. In another example, provisioning data stored in information server 300 may be accessed at user computer 400 by sales or support personnel using a web browser application provided by operational software 420.

In yet another example, a delivery person may scan and upload provisioning data and, optionally, supplemental data, to information server 300 upon delivery of HVAC components at a customer site. A reporting function is included in operational software 320 which identifies which HVAC components have been delivered to a site, which require installation, and which require provisioning. The report is forwarded to a sales or support person, who then makes arrangements for any additional site preparation that may be necessary, and to schedule an installation team to install the HVAC system. In an embodiment, operational software 320 generates job tickets for automated electronic delivery to an installation team. In an embodiment, the date on which the HVAC component was delivered or placed into service, and the location at which the HVAC component was first installed, is stored in information server 300. The acquisition of this data is useful, for example, for product registration and accurate administration of warranty benefits, service contracts, and rebates. The HVAC device characteristics may be additionally conveyed from information server 300 to a government agency to assist in the enforcement of compliance regulations, eligibility for tax credits, and the like. After physical installation, an installer utilizes software configuration application 140 of mobile device 100 to confirm that the HVAC equipment is installed, and to provision thermostat 100 and/or to update provisioning data stored at information server 300.

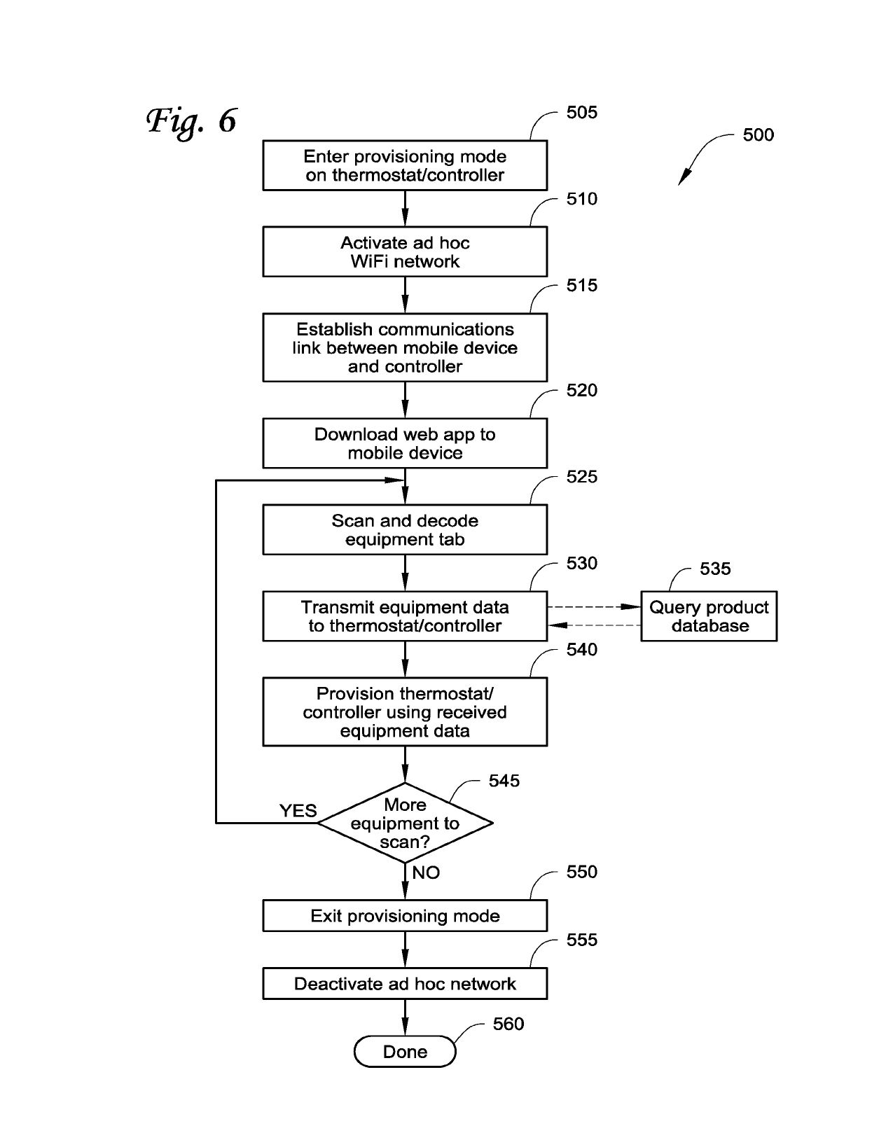

Turning to FIG. 6, a method of provisioning 500 an HVAC system in accordance with the present disclosure is illustrated. The method begins with step 505 wherein, at an HVAC system controller, such as a thermostat, a system provisioning mode is activated which enables the HVAC system controller to establish a communications link with a provisioning device, such as a mobile device. In step 510, an ad hoc wireless network (provisioning network) is established by the HVAC system controller. Note that, in some embodiments, the HVAC system controller may provide an ad hoc network as a default operating mode, which enables provisioning to occur at any time without a technician having to expressly activate the provisioning process. In step 515, a communications link is established between the HVAC system controller and the provisioning device. In embodiments, the communications link is established using the ad hoc wireless network. In embodiments, the communications link is established using a data network, such as the public Internet. In step 520, a software application is downloaded to the provisioning device. In embodiments, the software application is a web application transmitted from the HVAC system controller to the provisioning device. In step 525, a tag associated with an HVAC component is scanned and decoded into HVAC component data. In step 530, the decoded HVAC component data is transmitted to the HVAC system controller. Optionally, in step 535 at least a portion of the decoded HVAC component data is utilized to query a product database, which facilitates the retrieval of HVAC component data from the database. In a non-limiting example, at least a portion of the decoded HVAC component data may include a model number, a firmware version number, and/or a product serial number. The HVAC component data is utilized to query a product database, which in turn facilitates the retrieval of additional data which is not available, or unreadable, on the tag. In embodiments, if a portion of the tag is unreadable, corrupted, or otherwise unusable, a readable portion of the tag is identified and utilized to query the product database to ascertain the missing information.

The firmware version number of the decoded HVAC component data may be compared to the current firmware version available for that HVAC component. If the current firmware version is more recent than that indicated on the tag, the additional data retrieved from the product database and downloaded to the HVAC component may include a firmware update. In some embodiments, the user may be prompted to choose whether the update will be immediately downloaded and applied, or to schedule the update to happen at some future time. In some embodiment, the user may choose to automatically apply updates when available.

After the HVAC component is successfully updated to the new firmware, the product database is updated with the serial number and firmware version of the HVAC component, so that, during subsequent provisioning session, future firmware updates can be identified and applied when needed. In addition to provisioning data and firmware updates, operational features may be added or deleted. Hidden or locked features may be un-hidden or unlocked. In this manner, the HVAC component may be shipped in a base-level configuration, and premium features are enabled on-site based upon options or upgrades purchased by the consumer.

It should be understood that, in embodiments, the establishment of the provisioning network may be initiated at a device other than the system thermostat, and may include a controller included in one or more of the HVAC components, a system level controller (such as, for example and without limitation, a Tracer UC400 or Tracer UC600 BACnet controller manufactured by Trane International, Inc.), a dedicated service or diagnostic tool, etc. The provisioning network may be established prior to the thermostat being powered up.

In step 540 the HVAC system controller is provisioned with the HVAC component data. If a firmware update was downloaded, the update is applied to the HVAC component. Additional features are un-hidden or unlocked, as appropriate. If additional HVAC components remain to be scanned, in the step 545 the process iterates to step 525 whereupon a subsequent tag scan is performed. If no additional HVAC components need to be scanned, in step 550 the system provisioning mode of the HVAC system controller is deactivated, in step 555 the ad hoc wireless network is optionally deactivated, and in step 560 the process concludes.

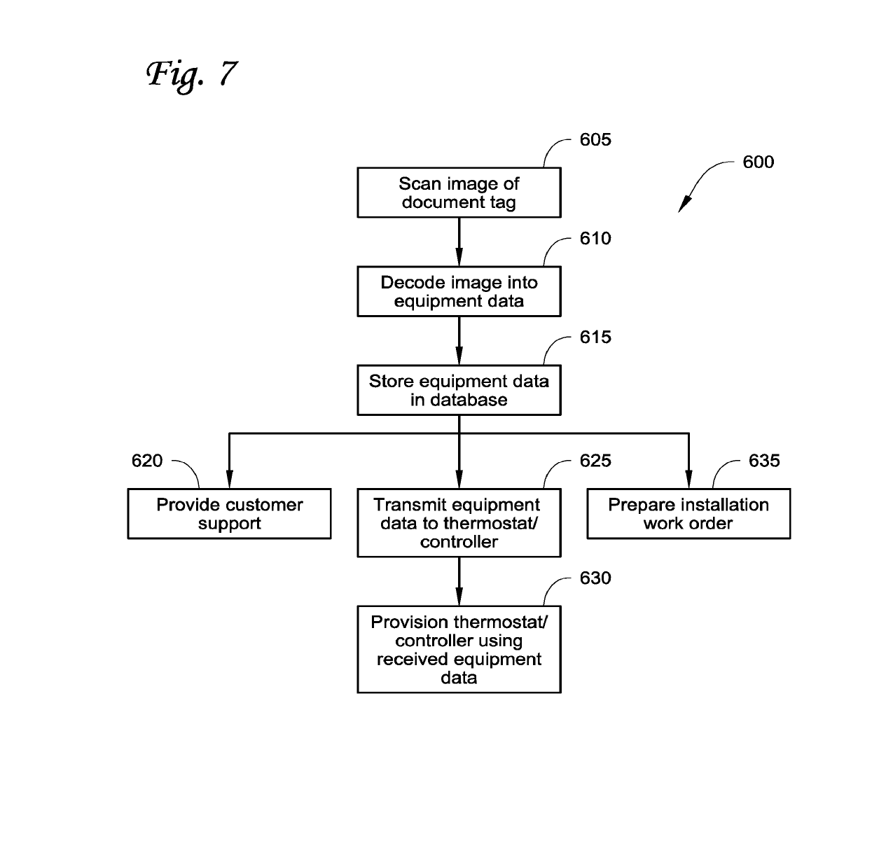

In FIG. 7, a method of managing 600 an HVAC system in accordance with the present disclosure is illustrated. In step 605, a tag associated with an HVAC component is scanned to create an image of the tag. In step 610, the scanned image is decoded into HVAC component data. In step 615, the decoded HVAC component data is stored in a database. The stored HVAC component data is then utilized in step 620 to provide customer support, such as, without limitation, initiating a communication with a customer (e.g., telephone call, email, SMS message), conducting a customer satisfaction survey, issuing a credit or coupon code, and so forth. In step 625, the stored HVAC component data is transmitted to an HVAC component, such as, without limitation, a thermostat, or a system controller. In step 630, the transmitted HVAC component data is utilized to provision an HVAC component. In step 635, the stored HVAC component data is utilized to generate an installation work order, and optionally cause the generated installation work order to be delivered to an installer.

### Aspects

It is noted that any of aspects 1-9 below can be combined with each other in any combination and combined with any of aspects 10-17, or any of aspects 18-20. Any of aspects 10-20 can be combined with each other in any combination.

Aspect 1. A method of provisioning an HVAC system controller, comprising activating, at the HVAC system controller, a system provisioning mode; causing a communications interface operatively coupled with the HVAC system controller to solicit a connection with a provisioning device; establishing a communications link between the HVAC system controller and a provisioning device; receiving, by the provisioning device, HVAC component data included in an image captured by the provisioning device; and provisioning the HVAC system controller with the HVAC component data included in the image.

Aspect 2. The method according to aspect 1, further comprising detecting when a communications link between the HVAC system controller and a provisioning device is established; and transmitting a configuration application from the HVAC system controller for reception by the provisioning device.

Aspect 3. The method according to any of aspects 1-2, wherein the configuration application causes the provisioning device to capture the image.

Aspect 4. The method according to any of aspects 1-3, wherein the configuration application causes the provisioning device to decode HVAC component data included in the image.

Aspect 5. The method according to any of aspects 1-4, wherein soliciting a connection with a provisioning device includes establishing an ad hoc wireless network.

Aspect 6. The method according to any of aspects 1-5, further comprising querying a product database using HVAC component data included in the image.

Aspect 7. The method according to any of aspects 1-6, further comprising receiving, at the HVAC system controller, additional HVAC component data from the product database; and provisioning the HVAC system controller with the additional HVAC component data.

Aspect 8. The method according to any of aspects 1-7, further comprising receiving, at the HVAC system controller, supplemental data from the provisioning device.

Aspect 9. The method according to any of aspects 1-8, further comprising provisioning the HVAC system controller with the supplemental data.

Aspect 10. A system for managing HVAC configuration data, comprising a mobile device configured to capture an image of an HVAC component; an image decoding module in operable communication with the mobile device configured to receive the image of the HVAC component and derive HVAC component data therefrom; and a database in operable communication with the image decoding module configured to store the HVAC component data.

Aspect 11. The system in accordance with aspect 10, further comprising an HVAC controller in operable communication with the database configured to receive the HVAC component data.

Aspect 12. The system in accordance with any of aspects 10-11, wherein the HVAC controller is configured to provision an operational parameter thereof in response to the received HVAC component data.

Aspect 13. The system in accordance with any of aspects 10-12, further comprising an information server in operable communication with the database configured to receive the HVAC component data.

Aspect 14. The system in accordance with any of aspects 10-13, wherein an image of an HVAC component includes an image of an HVAC component shipping container.

Aspect 15. The system in accordance with any of aspects 10-14, wherein an image of an HVAC component includes an image of an HVAC component tag.

Aspect 16. The system in accordance with any of aspects 10-15, wherein an image of an HVAC component includes indicia selected from the group consisting of a linear barcode, a two-dimensional barcode, and alphanumeric text.

Aspect 17. The system in accordance with any of aspects 10-16, further comprising a user computer in operable communication with the database and configured to display the image of an HVAC component to a user to enable the user to transcribe HVAC component data derived therefrom into the database.

Aspect 18. A method of managing an HVAC system, comprising receiving, from a provisioning device, an image of a tag associated with an HVAC component; deriving, at an image decoding module, HVAC component data from the image of the tag; storing, into a database, the derived HVAC component data; transmitting, to an HVAC controller, at least a part of the derived HVAC component data; and provisioning the HVAC controller with the transmitted HVAC component data.

Aspect 19. The method in accordance with aspect 18, further comprising determining an operational status of the HVAC system from the HVAC component data; generating a work order based upon the operational status of the HVAC system; and delivering the work order to a service provider.

Aspect 20. The method in accordance with any of aspects 18-19, further comprising determining, from the derived HVAC component data, an operational parameter relating to the HVAC system; transmitting, to the HVAC controller, the operational parameter; and provisioning the HVAC controller with the operational parameter.

Aspect 21. The method in accordance with any of aspects 18-20, further comprising querying a database with derived HVAC component data to obtain the operational parameter.

Aspect 22. The method in accordance with any of aspects 18-21, further comprising receiving, from the provisioning device, a geographic location of the HVAC component; and storing, into the database, the geographic location of the HVAC component.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

What is claimed is:

1. A method of provisioning an HVAC system controller, comprising:
activating, at the HVAC system controller, a system provisioning mode;
causing a communications interface operatively coupled with the HVAC system controller to solicit a connection with a provisioning device;
establishing a communications link between the HVAC system controller and the provisioning device;
receiving, by the provisioning device, HVAC component data included in an image captured by the provisioning device; and
provisioning the HVAC system controller with the HVAC component data included in the image.

2. The method in accordance with claim 1, further comprising:
detecting when a communications link between the HVAC system controller and a provisioning device is established; and
transmitting a configuration application from the HVAC system controller for reception by the provisioning device.

3. The method in accordance with claim 2, wherein the configuration application causes the provisioning device to capture the image.

4. The method in accordance with claim 2, wherein the configuration application causes the provisioning device to decode HVAC component data included in the image.

5. The method in accordance with claim 1, wherein soliciting a connection with a provisioning device includes establishing an ad hoc wireless network.

6. The method in accordance with claim 1, further comprising querying a product database using HVAC component data included in the image.

7. The method in accordance with claim 6, further comprising:
receiving, at the HVAC system controller, additional HVAC component data from the product database; and
provisioning the HVAC system controller with the additional HVAC component data.

8. The method in accordance with claim 1, further comprising receiving, at the HVAC system controller, supplemental data from the provisioning device.

9. The method in accordance with claim 8, further comprising provisioning the HVAC system controller with the supplemental data.

10. A system for managing HVAC configuration data, comprising:
a mobile device configured to capture an image of an HVAC component;
an image decoding module in operable communication with the mobile device configured to receive the image of the HVAC component and derive HVAC component data therefrom; and
a database in operable communication with the image decoding module configured to store the HVAC component data.

11. The system in accordance with claim 10, further comprising an HVAC controller in operable communication with the database configured to receive the HVAC component data.

12. The system in accordance with claim 11, wherein the HVAC controller is configured to provision an operational parameter thereof in response to the received HVAC component data.

13. The system in accordance with claim 10, further comprising an information server in operable communication with the database configured to receive the HVAC component data.

14. The system in accordance with claim 10, wherein an image of an HVAC component includes an image of an HVAC component shipping container.

15. The system in accordance with claim 10, wherein an image of an HVAC component includes an image of an HVAC component tag.

16. The system in accordance with claim 10, wherein an image of an HVAC component includes indicia selected from the group consisting of a linear barcode, a two-dimensional barcode, and alphanumeric text.

17. The system in accordance with claim 10, further comprising a user computer in operable communication with the database and configured to display the image of an HVAC component to a user to enable the user to transcribe HVAC component data derived therefrom into the database.

18. A method of managing an HVAC system, comprising:
receiving, from a provisioning device, an image of a tag associated with an HVAC component;
deriving, at an image decoding module, HVAC component data from the image of the tag;
storing, into a database, the derived HVAC component data;
transmitting, to an HVAC controller, at least a part of the derived HVAC component data; and
provisioning the HVAC controller with the transmitted HVAC component data.

19. The method in accordance with claim 18, further comprising:
determining an operational status of the HVAC system from the HVAC component data;
generating a work order based upon the operational status of the HVAC system; and
delivering the work order to a service provider.

20. The method in accordance with claim 18, further comprising:
determining, from the derived HVAC component data, an operational parameter relating to the HVAC system;
transmitting, to the HVAC controller, the operational parameter; and
provisioning the HVAC controller with the operational parameter.

21. The method in accordance with claim 20, wherein the determining includes querying a database with derived HVAC component data to obtain the operational parameter.

22. The method in accordance with claim 18, further comprising:
receiving, from the provisioning device, a geographic location of the HVAC component; and
storing, into the database, the geographic location of the HVAC component.
